(19) United States
(12) Patent Application Publication
(10) Pub. No.: US 2026/0056801 A1
(43) Pub. Date: Feb. 26, 2026

(54) SCHEDULING NEURAL NETWORK EXECUTION IN MULTI-CORE ENVIRONMENTS

(71) Applicant: TEXAS INSTRUMENTS INCORPORATED, Dallas, TX (US)

(72) Inventors: Mihir Mody, Bangalore (IN); Pramod Swami, Bangalore (IN); Anshu Jain, Bangalore (IN)

(21) Appl. No.: 18/814,088

(22) Filed: Aug. 23, 2024

(51) Int. Cl. G06F 9/50

(52) U.S. Cl. CPC G06F 9/505

(57) ABSTRACT

Various embodiments of the present disclosure relate to scheduling the execution of one or more neural networks, and in particular, to scheduling the execution of one or more neural networks within the context of a multi-core environment. In one example embodiment, a technique for scheduling neural network execution across multiple processing cores is provided. The technique first includes identifying a plurality of workload fragments of a neural network based on a sensor type and a desired latency associated with each workload fragment. Next, the technique includes determining an execution time for executing each workload fragment. Finally, the technique includes generating a schedule for executing the neural network across multiple processing cores based on the desired latency associated with each workload fragment, and the execution time for executing each workload fragment.

### TECHNICAL FIELD

Aspects of the disclosure are related to the field of computing hardware and software and more particularly to scheduling the execution of neural networks on a multi-core device.

### BACKGROUND

A multi-core device is representative of a type of processing device which includes multiple processing cores. For example, a multi-core device may be representative of a System-on-a-Chip (SoC), application specific integrated circuit (ASIC), or another device of the like including multiple processing cores. The multiple processing cores of the multi-core device are representative of processing units configured to execute program code. For example, the multiple processing cores may be representative of digital signal processors (DSPs) configured to execute one or more neural networks.

Traditional methods for executing one or more neural networks on a multi-core device are based on a predetermined execution schedule. The predetermined execution schedule is representative of a user generated schedule which delegates the workloads of the one or more networks to the processing cores of the multi-core device. For example, if the multi-core device is configured to execute two neural networks, then, prior to the deployment of the networks, a user associated with the multi-core device may provide an execution schedule which instructs a first processing core to maintain the workload of the first neural network and instructs a second processing core to maintain the workload of the second neural network. Once instructed, the multi-core device may deploy the neural networks and in response, the first processing core may begin receiving input for executing the first neural network, and the second processing core may begin receiving input for executing the second neural network.

Problematically, current methods for determining a schedule for executing one or more neural networks on a multi-core device rely on user input, and thus fail to optimize the workloads of the networks across the multiple processing cores. As a result, traditional methods for executing one or more neural networks on a multi-core device may be inefficient and inaccurate.

### SUMMARY

Disclosed herein is technology, including systems, methods, and devices for scheduling the execution of one or more neural networks within the context of a multi-core environment. In various implementations, a technique for scheduling neural network execution on multiple processing cores is provided. In one example embodiment the technique first includes identifying a plurality of workload fragments of one or more neural networks based on a sensor type and a desired latency associated with each workload fragment. Next, the technique includes determining an execution time for executing each workload fragment. Finally, the technique includes generating a schedule for executing the one or more neural networks across multiple processing cores such that the schedule is generated based on the desired latency associated with each workload fragment, and further based on the execution time for executing each workload fragment.

This Summary is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operational environment in an implementation.

FIG. 2 illustrates a scheduling method in an implementation.

FIG. 3 illustrates a system in an implementation.

FIG. 4A illustrates another operational environment in an implementation.

FIG. 4B illustrates an operational scenario in an implementation.

FIG. 5A illustrates a partitioning process in an implementation.

FIG. 5B illustrates another scheduling process in an implementation.

FIG. 6 illustrates a table in an implementation.

FIG. 7 illustrates another operational scenario in an implementation.

FIG. 8 illustrates a split type table in an implementation.

FIG. 9 illustrates another operational scenario in an implementation.

FIG. 10 illustrates a computing system suitable for implementing the various operational environments, architectures, processes, scenarios, and sequences discussed below with respect to the other Figures.

### DETAILED DESCRIPTION

Technology is disclosed herein for scheduling the execution of one or more neural networks on a multi-core device. Multi-core devices are representative of devices which include multiple processing cores configured to execute program code. For example, a multi-core device may be representative of a System-on-a-Chip (SoC) which comprises multiple digital signal processors (DSPs) configured to execute one or more neural networks.

Generally, neural networks comprise a series of interconnected layers configured to perform a designated task. For example, such tasks may include image classification, image segmentation, object detection, or other processing tasks of the like. To execute a neural network on a multi-core device, the workload of the network must be evaluated to determine a schedule for executing the network across the multiple processing cores. The workload of a neural network describes the amount of work required to perform a designated task. For example, the workload of a network configured to perform image classification describes the amount of work an associated processing core must perform to classify an image.

Existing techniques for scheduling neural network execution on a multi-core device are dependent on user input. For example, a user associated with the multi-core device may provide an execution schedule for deploying one or more neural networks. The execution schedule is representative of a user generated schedule which delegates the workloads of the neural networks to the multiple processing cores. For example, if the multi-core device is configured to execute three separate neural networks, then the execution schedule may delegate the workload of the first neural network to a first processing core, the workload of the second neural network to a second processing core, and the workload of the third neural network to a third processing core. Problematically, the user generated execution schedule fails to optimize the workloads of the networks and in turn reduces the efficiency of the multi-core device. In contrast, disclosed herein is a new technique for scheduling the execution of one or more neural networks on a multi-core device which is based on the workload requirements of the one or more neural networks, and by design, improves the efficiency, operating speed, and/or case of use of the multi-core device.

In one example embodiment a computer-readable medium having executable instructions related to scheduling neural network execution in a multi-core system is provided. The multi-core system is representative of a multi-core device which is coupled to the computer-readable medium and includes multiple processing cores. The instructions of the computer-readable medium are configured to be executed by processing circuitry of the multi-core system, such that when executed, the instructions cause the processing circuitry to evaluate the workloads of one or more neural networks to generate an execution schedule for executing the one or more neural networks. For the purposes of explanation, the following example will be described from the perspective of scheduling the execution of a singular neural network. This is not meant to limit the applications of the proposed technology, but rather to provide an example.

To begin, the program instructions first cause the processing circuitry to identify a plurality of workload fragments of a neural network based on a sensor type and a desired latency associated with each workload fragment. A workload fragment is representative of a section of a workload of a neural network. For example, a neural network may include multiple workload fragments such that the total number of workload fragments represents the total workload of the network.

Next, the program instructions cause the processing circuitry to determine an execution time for executing each workload fragment. In an implementation, to determine the execution time for executing each workload fragment, the program instructions cause the processing circuitry to simulate the execution of each workload fragment with respect to a partial system under test (PSUT). A PSUT is representative of a multi-core system where only one processing core of the multiple processing cores is utilized. For example, the program instructions may cause the processing circuitry to determine the execution times for executing each workload fragment by simulating the execution of each workload fragment via a singular processing core of the multi-core system.

Once the execution times are determined, the program instructions cause the processing circuitry to generate a schedule for executing the neural network based on the desired latency associated with each workload fragment, and the execution time for executing each workload fragment. The desired latency associated with a workload fragment describes the amount of time an associated sensor (e.g., camera) allots a processing core to execute the fragment. For example, if the desired latency associated with a workload fragment is equal to 15 milliseconds, then an associated processing core has 15 milliseconds to execute the workload fragment. In an implementation, the program instructions cause the processing circuitry to generate a schedule which satisfies the desired latency associated with each workload fragment by ensuring the execution time for executing each workload fragment is less than the associated latency.

Advantageously, the proposed technology allows a multi-core system to optimize the execution schedule for executing one or more neural networks based on the workload requirements of the networks. As a result, the proposed solution may be more efficient, faster, and/or easy to use than applications which require a user to provide the execution schedule.

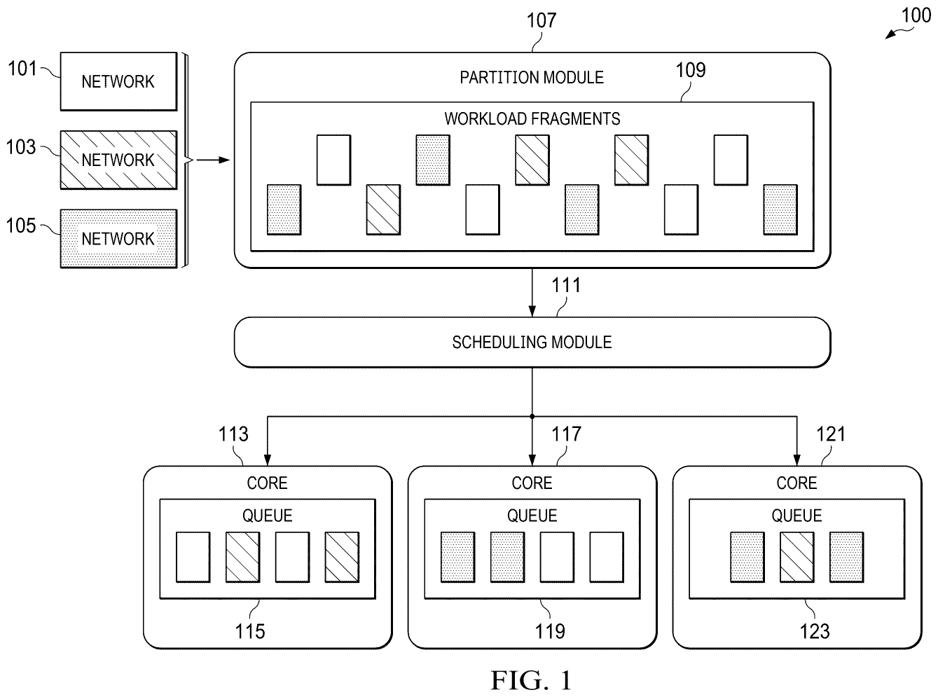

Now turning to the figures, FIG. 1 illustrates operating environment 100 in an implementation. Operating environment 100 is representative of an example environment configurable to schedule and execute one or more neural networks across multiple processing cores. For example, operating environment 100 may be representative of a multi-core system configured to generate an execution schedule for executing one or more neural networks across multiple processing cores. Operating environment 100 may be implemented in a variety of use-cases such as automotive, industrial, robotics, language processing, power electronics, autonomous systems, computer vision, image processing, radar, and/or audio processing. Operating environment 100 may include multiple sensors in a heterogenous sensor-fusion system. Operating environment 100 includes, but is not limited to, networks 101, 103, and 105, partition module 107, scheduling module 111, and cores 113, 117, and 121. It should be noted that, for the purposes of explanation operating environment 100 has been illustrated to include three neural networks and three processing cores. This is not meant to limit the applications of operating environment 100, but rather to provide an example.

Networks 101, 103, and 105 are representative of neural networks configured to perform a designated task. For example, the networks may represent convolutional neural networks (CNNs), artificial neural networks (ANNs), recurrent neural networks (RNNs), or another deep neural network of the like (DNN) configured to perform a task such as, image classification, image segmentation, or object detection. It should be noted that networks 101, 103, and 105 may represent the same type of network (e.g., CNN), different types of networks (e.g., CNN, RNN, and ANN), or a combination of network types. It should further be noted that networks 101, 103, and 105 may be configured to perform the same task (e.g., image classification), different tasks (e.g., image classification, image segmentation, and object detection), or a combination thereof.

In an implementation, networks 101, 103, and 105 are also representative of workloads for the processing cores of operating environment 100. A workload describes the amount of work a processing core must perform to execute a network. For example, if network 101 is configured to perform object detection, then the workload of network 101 describes the amount of work a processing core must perform to detect an object (i.e., execute network 101). In an implementation, prior to the deployment of the networks, networks 101, 103, and 105 are supplied as input to partition module 107.

Partition module 107 is representative of software, hardware, firmware, or a combination thereof, configured to partition the workloads of networks 101, 103, and 105. For example, partition module 107 may be representative of a central processing unit (CPU) configured to partition the workloads of networks 101, 103, and 105 into workload fragments 109. Workload fragments 109 are representative of sections of the workloads of networks 101, 103, and 105. In an implementation, partition module 107 is configured to partition the workloads of each network into a number of workload fragments, such that the number of workload fragments is equal to the total workload of the network. For example, partition module 107 may partition the workload of network 101 into four separate workload fragments, such that the four separate fragments are representative of the entire workload of network 101. In an implementation, after partitioning the workloads of each network, partition module 107 outputs workload fragments 109 to scheduling module 111.

Scheduling module 111 is representative of software, hardware, firmware, or a combination thereof, configured to schedule the execution of networks 101, 103, and 105 across multiple processing cores. For example, scheduling module 111 may be representative of a CPU configured to schedule the execution of workload fragments 109 across cores 113, 117, and 121. In an implementation, to schedule the execution of workload fragments 109, scheduling module 111 generates an execution schedule based on a desired latency associated with each fragment and an execution time for executing each fragment. The desired latency associated with each workload fragment describes the amount of time an associated sensor (e.g., radar device) allots a processing core to execute the fragment. Alternatively, the execution time for executing each workload fragment describes the amount of time a processing core requires to execute the fragment.

In an implementation, to determine the execution times for executing each fragment of workload fragments 109, scheduling module 111 simulates the execution of the fragments on a partial system under test (PSUT). A PSUT is representative of a multi-core system which utilizes a singular core for testing. For example, operating environment 100 may be representative of a PSUT. In an implementation, scheduling module 111 utilizes a single core of operating environment 100 to simulate a PSUT environment and determine the execution times for executing workload fragments 109. For example, scheduling module 111 may instruct core 113 to execute workload fragments 109, and in response, scheduling module 111 may identify the time it took core 113 to execute each fragment of workload fragments 109. As a result, scheduling module 111 may generate the execution schedule for executing workload fragments 109, such that the execution schedule ensures the execution times for executing each workload fragment is less than the desired latency associated with each workload fragment. In an implementation, after generating the execution schedule for executing workload fragments 109, scheduling module 111 may supply the fragments of workload fragments 109 to cores 113, 117, and 121 based on the generated schedule. Additional example details of scheduling workloads for a neural network can be found in commonly assigned U.S. Patent Application Publication No. 2023/0252328, entitled “Scheduling of Inference Models Based on Preemptable Boundaries,” filed Jan. 12, 2023, which is incorporated by reference in its entirety.

Cores 113, 117, and 121 are representative of processing cores configured to execute program code. For example, cores 113, 117, and 121 may be representative of CPUs, ASICS, digital signal processors (DSPs), microcontroller units (MCUs), graphics processing units (GPUs), tensor processing units (TPUs), or another general-purpose processor (GPP) of the like which is configured to maintain the workloads of networks 101, 103, and 105. In an implementation, cores 113, 117, and 121 are coupled to one or more sensors (not shown) configured to provide input data to networks 101, 103, and 105. For example, cores 113, 117, and 121 may be coupled to a camera configured to collect image data, a radar device configured to collect radar data, a microphone configured to collect audio data, or another device of the like configured to collect input data for executing networks 101, 103, and 105. Cores 113, 117, and 121 respectively include queues 115, 119, and 123.

Queues 115, 119, and 123 are representative of locations which store workload fragments 109. For example, queue 115 stores the workload fragments which are to be executed by core 113, queue 119 stores the workload fragments which are to be executed by core 117, and queue 123 stores the workload fragments which are to be executed by core 121. During operation, cores 113, 117, and 121 may receive input data from one or more sensors and in response, execute the workload fragments of their respective queue, based on the order in which the fragments are stored.

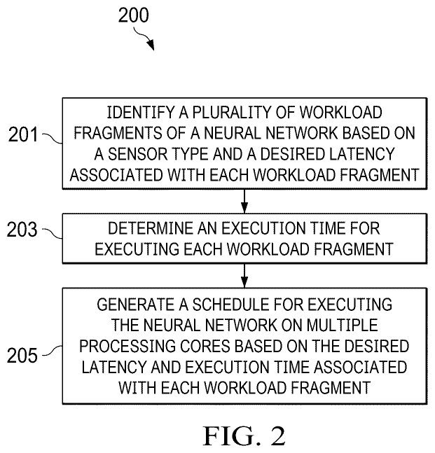

FIG. 2 illustrates scheduling method 200 in an implementation. Scheduling method 200 is representative of software for scheduling the execution of one or more neural networks within the context of a multi-core environment. Scheduling method 200 may be implemented in the context of program instructions that, when executed by a suitable computing system, direct the processing circuitry of the computing system to operate as follows, referring parenthetically to the steps in FIG. 2. For the purposes of explanation, scheduling method 200 will be explained with the elements of FIG. 1. This is not meant to limit the applications of scheduling method 200, but rather to provide an example.

To begin, partition module 107 identifies a plurality of workload fragments from each network of operating environment 100 based on a sensor type and a desired latency associated with each workload fragment (step 201). Partition module 107 can identify the workload fragments by selecting each fragment from the network(s) and/or by splitting a workload into the workload fragments. The sensor type describes the sensor resolution of a sensor which is configured to collect data for executing the workload fragment. The desired latency describes the amount of time the sensor allots for executing the workload fragment. In an implementation, partition module 107 analyzes the sensor type and desired latency associated with networks 101, 103, and 105 to identify workload fragments 109.

Next, partition module 107 supplies workload fragments 109 to scheduling module 111, and in response, scheduling module 111 determines an execution time for executing each fragment of workload fragments 109. In an implementation, to determine the execution times for executing each fragment of workload fragments 109, scheduling module 111 simulates the execution of workload fragments 109 via a processing core of operating environment 100. For example, scheduling module 111 may instruct core 113 to execute workload fragments 109 to identify the execution times for executing each fragment of workload fragments 109.

Finally, scheduling module 111 generates a schedule for executing networks 101, 103, and 105 across cores 113, 117, and 121 by generating an execution schedule for workload fragments 109 based on the execution time and desired latency associated with each fragment (step 205). The execution schedule is representative of a schedule that ensures the execution times for executing each fragment of workload fragments 109 satisfies the associated latency. In an implementation, after generating the execution schedule, scheduling module 111 may output the various fragments of workload fragments 109 to the appropriate processing core.

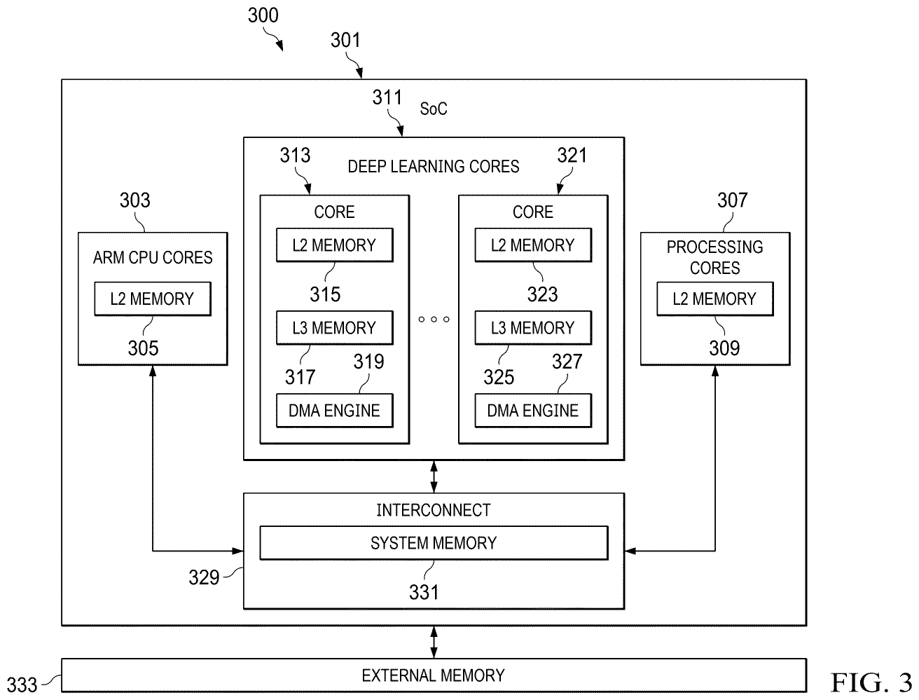

Now turning to the next figure, FIG. 3 illustrates system 300 in an implementation. System 300 is representative of a multi-core system configured to schedule and execute one or more neural networks across multiple processing cores. For example, system 300 may be representative of operating environment 100 of FIG. 1. System 300 includes SoC 301 and external memory 333.

SoC 301 is representative of a multi-core device configured to schedule the execution of one or more neural networks across multiple processing cores. For example, SoC 301 may be representative of a device configured to schedule the execution of networks 101, 103, and 105 across deep learning cores 311. SoC 301 includes CPU cores 303, processing cores 307, deep learning cores 311, and data interconnect 329.

CPU cores 303 are representative of processing cores configured to manage the execution of one or more neural networks. For example, CPU cores 303 may be representative of ARM processing cores configured to generate an execution schedule for executing one or more neural networks across deep learning cores 311. In an implementation, CPU cores 303 are representative of partition module 107 and scheduling module 111 of FIG. 1.

CPU cores 303 include L2 memory 305. L2 memory 305 is representative of a memory configured to store data of CPU cores 303. For example, L2 memory 305 may store program instructions (e.g., scheduling method 200), that when executed, causes CPU cores 303 to generate an execution schedule for executing one or more neural networks across deep learning cores 311.

Processing cores 307 are representative of processing units configured to manage other system requirements of SoC 301. For example, processing cores 307 may represent CPUs, ASICS, DSPs, MCUs, GPUs, TPUs, or another GPP of the like configured to execute program code. In an implementation, processing cores 307 are representative of processing cores configured to aid in the execution of one or more neural networks. For example, processing cores 307 may be representative of matrix multiply accelerators (MMAs) configured to perform matrix operations for deep learning cores 311. Processing cores 307 include L2 memory 309. L2 memory 309 is representative of a memory configured to store data of processing cores 307. For example, L2 memory 309 may store program instructions, that when executed, causes processing cores 307 to perform matrix operations for executing one or more neural networks.

Deep learning cores 311 are representative of processing cores configured to execute one or more neural networks. For example, deep learning cores 311 may represent an ASIC comprising multiple processing cores configured to execute one or more neural networks. Deep learning cores 311 includes core 313 and core 321. It should be noted that for the purposes of explanation, deep learning cores 311 has been illustrated to include two processing cores. This is not meant to limit the applications of deep learning cores 311, but rather to provide an example.

Cores 313 and 321 are representative of processing units configured to maintain the workloads of one or more neural networks. For example, cores 313 and 321 may be representative of cores 113, 117, and 121 of FIG. 1. In an implementation, cores 313 and 321 are representative of DSPs configured to execute one or more neural networks. For example, cores 313 and 321 may be coupled to sensors configured to collect input data for executing one or more neural networks. Cores 313 and 321 respectively include L2 memories 315 and 323, L3 memories 317 and 325, and DMA engines 319 and 327.

L2 memories 315 and 323 are representative of memories configured to respectively store data for core 313 and core 321. For example, L2 memories 315 and 323 may store program instructions, that when executed, causes cores 313 and 321 to maintain the workloads of the neural networks. Alternatively, L3 memories 317 and 325 are representative of a common memory configured to store data of cores 313 and 321. For example, L3 memories 317 and 325 may store outputs of the neural networks.

DMA engines 319 and 327 are representative of processing circuitry configured to perform direct memory access transfers from a first location in memory to a second location in memory. For example, DMA engines 319 and 327 may transfer data from L3 memories 315 and 323 to system memory 331. In another example, DMA engines 319 and 327 may transfer data from L2 memories 305 and 309 to L2 memories 315 and 323. In an implementation, DMA engines 319 and 327 transfer data via data interconnect 329.

Data interconnect 329 is representative of circuitry configured to host communications between the elements of SoC 301. For example, data interconnect 329 may host the communications between CPU cores 303 and deep learning cores 311. In an implementation, data interconnect 329 is further representative of circuitry configured to host communications between SoC 301 and external elements. For example, data interconnect 329 may host the communication between SoC 301 and external memory 333. Data interconnect 329 includes system memory 331.

System memory 331 is representative of an on-chip memory configured to store data of SoC 301. For example, system memory 331 may be representative of flash memory, L4 memory, static random-access memory (SRAM), or another memory of the like configured to store the program code associated with one or more neural networks. In an implementation, CPU cores 303 interface with data interconnect 329 to examine the workloads of the neural networks stored in system memory 331. For example, CPU cores 303 may partition the workloads of the networks stored in system memory 331 and generate a schedule for executing the partitioned workloads across deep learning cores 311.

External memory 333 is representative of one or more volatile or non-volatile computer-readable storage media including instructions, data, and the like. For example, external memory 333 may be representative of random-access memory, flash memory, or another off-chip memory of the like configured to store data of SoC 301. In an implementation, external memory 333 is configured to store data for when on-device memory of SoC 301 is insufficient.

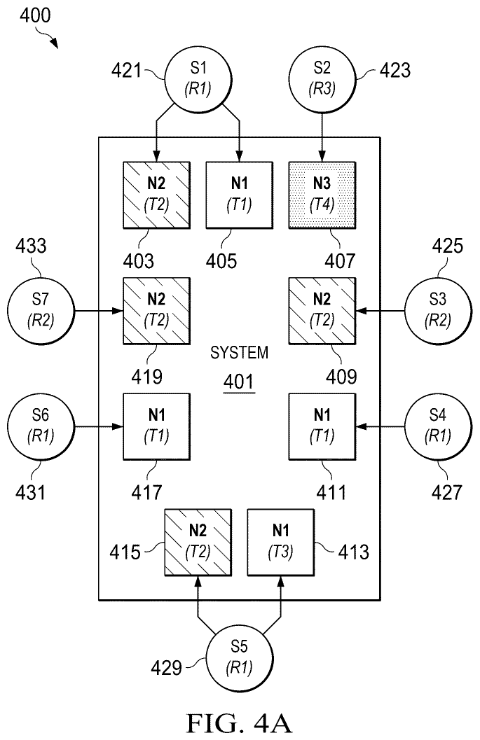

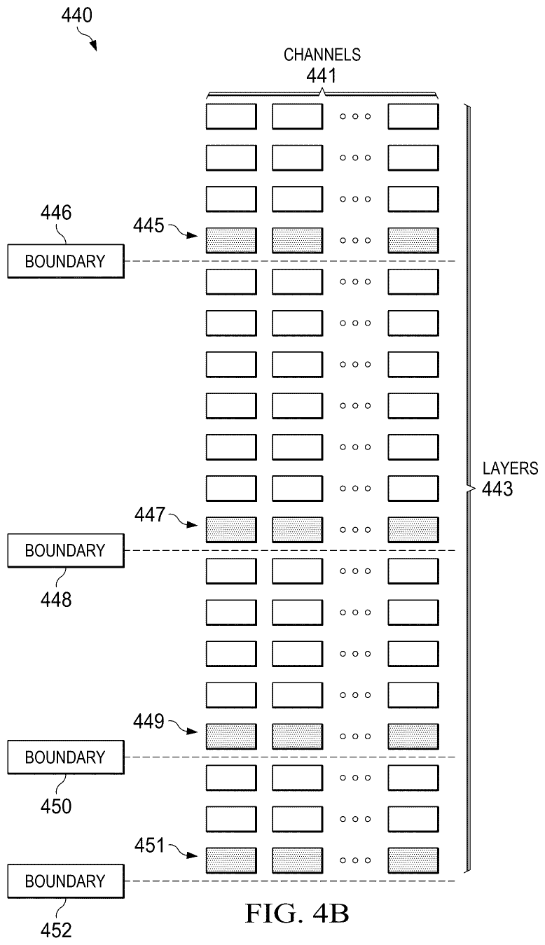

FIG. 4A illustrates operating environment 400 in an implementation. Operating environment 400 is representative of an example environment configurable to execute multiple neural networks across multiple processing cores. For example, operating environment 400 may be representative of an electric vehicle (EV) configured to collect input data for executing multiple neural networks across multiple processing cores. Operating environment 400 includes system 401, first resolution sensors 421, 427, 429, and 431, second resolution sensors 425 and 433, and third resolution sensor 423.

System 401 is representative of a device configured to schedule and execute multiple neural networks. For example, system 401 may be representative of system 300 of FIG. 3. In an implementation, system 401 is also representative of a device configured to collect input data for executing the multiple neural networks. System 401 includes, but is not limited to, networks 403, 405, 407, 409, 411, 413, 415, 417, and 419.

Networks 405, 411, 413, and 417 are representative of neural networks configured to perform the same task. For example, networks 405, 411, 413, and 417 may be representative of CNNs, ANNs, or RNNs, configured to perform image classification. In an implementation, networks 405, 411, 413, and 417 receive input data from an associated input sensor. For example, network 405 may be coupled to first resolution sensor 421, network 411 may be coupled to first resolution sensor 427, network 413 may be coupled to first resolution sensor 429, and network 417 may be coupled to first resolution sensor 431.

First resolution sensors 421, 427, 429, and 431 are representative of sensors configured to collect input data for executing one or more networks. For example, first resolution sensors 421, 427, 429, and 431 may be representative of cameras, microphones, radar devices, or another sensor of the like. In an implementation, first resolution sensors 421, 427, 429, and 431 are configured to collect data at a specified resolution. For example, first resolution sensors 421, 427, 429, and 431 may be representative of cameras configured to collect images at a resolution of 600 pixels-per-inch (PPI). In an implementation, networks 405, 411, 413, and 417 must be executed within a desired latency of the respective input sensor. The desired latency describes the amount of time a sensor allots for executing a network. For example, networks 405, 411, and 417 must be executed within a latency of T1, while network 413 must be executed within a latency of T3.

Networks 403, 409, 415, and 419 are also representative of neural networks configured to perform the same task. For example, networks 403, 409, 415, and 419 may be representative of CNNs, ANNs, or RNNs, configured to perform object detection. In an implementation, networks 403, 409, 415, and 419 receive input data from an associated input sensor. For example, network 403 may be coupled to first resolution sensor 421, network 409 may be coupled to second resolution sensor 425, network 415 may be coupled to first resolution sensor 429, and network 419 may be coupled to second resolution sensor 433.

Second resolution sensors 425 and 433 are representative of sensors configured to collect input data for executing one or more networks. For example, second resolution sensors 425 and 433 may be representative of cameras, microphones, radar devices, or another sensor of the like. In an implementation, second resolution sensors 425 and 433 are configured to collect data at a specified resolution. For example, second resolution sensors 425 and 433 may be representative of cameras configured to collect images at a resolution of 300 PPI. In an implementation, networks 403, 409, 415, and 419 must be executed within a desired latency of the respective input sensor. For example, networks 403, 409, 415, and 419 must be executed within a latency of T2.

Network 407 is representative of a neural network configured to perform a designated task. For example, network 407 may be representative of a CNN, ANN, or RNN, configured to perform image segmentation. In an implementation, network 407 is configured to receive input data from third resolution sensor 423.

Third resolution sensor 423 is representative of a sensor configured to collect input data for executing one or more networks. For example, third resolution sensor 423 may be representative of a camera, microphone, radar device, or another sensor of the like. In an implementation, third resolution sensor 423 is configured to collect data at a specified resolution. For example, third resolution sensor 423 may be representative of a camera configured to collect images at a resolution of 150 PPI. In an implementation, network 407 must be executed within a desired latency of third resolution sensor 423. For example, network 407 must be executed within a latency of T4.

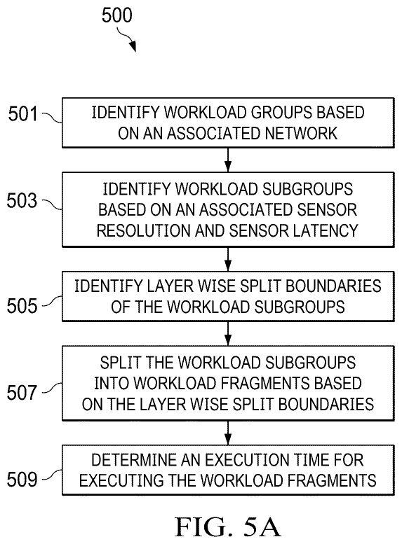

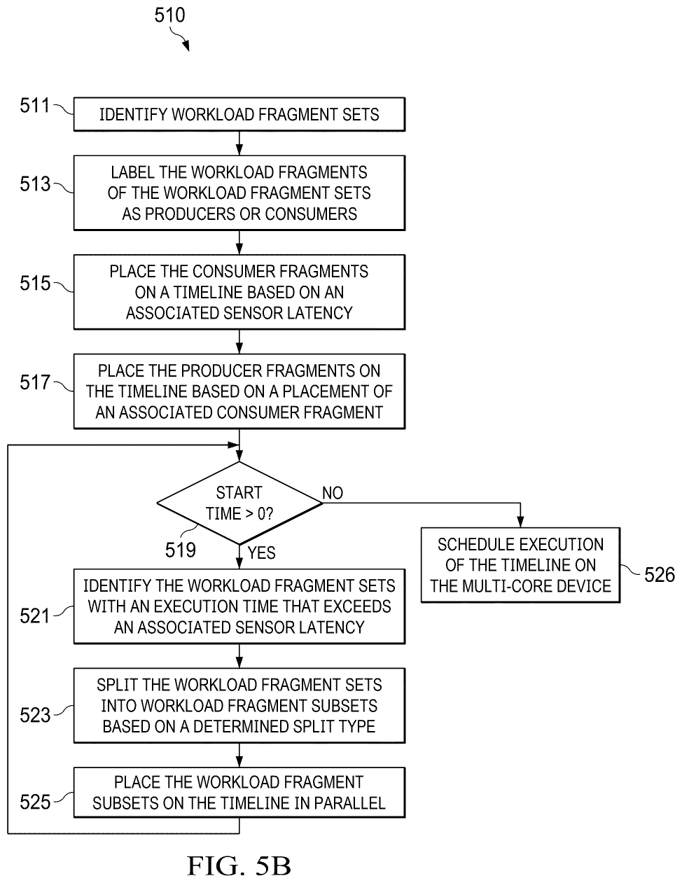

In an implementation, prior to the deployment of the networks, system 401 generates an execution schedule for executing the multiple networks based on the workload requirements of the networks. The execution schedule is representative of a timeline which delegates the workloads of each network to the processing cores of system 401. The workload of a network describes the amount of work a processing core must perform to execute the network. In an implementation, system 401 partitions the workloads of networks 403, 405, 407, 409, 411, 413, 415, 417, and 419 into a number of workload fragments and generates an execution schedule for executing the workload fragments, later discussed in detail with reference to FIGS. 5A and 5B.

FIG. 4B illustrates operational scenario 440 in an implementation. Operational scenario 440 is representative of a scenario for partitioning the workload of a neural network. For the purposes of explanation, operational scenario 440 will be explained within the context of operating environment 400. More specifically, operational scenario 440 will be explained with respect to network 405. This is not meant to limit the applications of operational scenario 440, but rather to provide an example. Operational scenario 440 includes channels 441, layers 443, output data layers 445, 447, 449, and 451, and layer boundaries 446, 448, 450, and 452.

Channels 441 are representative of the various processing channels of network 405. A processing channel of a network is representative of a channel which is dedicated to processing specific sections of data. For example, if network 405 performs operations on red-green-blue images, then channels 441 may include three channels, such that the first channel is representative of a channel for processing red pixel data, the second channel is representative of a channel for processing green pixel data, and the third channel is representative of a channel for processing blue pixel data.

Layers 443 are representative of the various processing layers of network 405. For example, network 405 may contain an input layer, multiple hidden layers, and an output layer. In an implementation network 405 includes output data layers 445, 447, 449, and 451. Output data layers 445, 447, 449, and 451 are representative of layers which output data to memory. For example, output data layers 445, 447, 449, and 451 may output data to a double data rate (DDR) memory of system 401.

In an implementation, system 401 partitions the workload of a network based on the output data layers of the network. For example, system 401 may identify output data layers 445, 447, 450, and 451, of network 405 and respectively assign layer boundaries 446, 448, 450, and 452 to the output data layers of network 405. Next, system 401 may partition the workload of network 405 into multiple workload fragments based on a location of layer boundaries 446, 448, 450, and 452. As a result, system 401 may partition network 405 into a total of four workload fragments.

Now turning to the next figure, FIG. 5A illustrates partitioning process 500 in an implementation. Partitioning process 500 is representative of a process for partitioning the workloads of one or more neural networks into a number of workload fragments. For example, partitioning process 500 may be representative of scheduling method 200 of FIG. 2. Partitioning process 500 may be implemented in the context of program instructions that, when executed by a suitable computing system, direct the processing circuitry of the computing system to operate as follows, referring parenthetically to the steps in FIG. 5A. For the purposes of explanation, partitioning process 500 will be explained with the elements of FIGS. 4A and 4B. This is not meant to limit the applications of partitioning process 500, but rather to provide an example.

To begin, system 401 analyzes networks 403, 405, 407, 409, 411, 413, 415, 417, and 419 to identify or designate a number of workload groups (step 501). A workload group is representative of a group of workloads which are configured to perform the same task. For example, system 401 may designate (e.g., assign, label, or associate) networks 405, 411, 413, and 417 as a first workload group, networks 403, 409, 415, and 419 as a second workload group, and network 407 as a third workload group.

Next, system 401 analyzes the workload groups to identify one or more workload subgroups based on an associated sensor resolution and associated sensor latency (step 503). System 401 may be configured to perform step 503 by splitting each workload group identified in step 501 into one or more workload subgroups. For example, system 401 may be configured to assign each network to a subgroup, label each network as a member of a subgroup, or associate each network with a subgroup. The associated sensor resolution describes the resolution an associated sensor is configured to collect data, while the associated sensor latency describes the duration of time the associated sensor allots a processing core to execute a respective network. For example, the associated sensor resolution of first resolution sensor 421 is equal to R1, while the associated sensor latency for executing network 405 is equal to T1. In an implementation, system 401 designates networks 405, 411, and 417 as a first workload subgroup, network 413 as a second workload subgroup, networks 409 and 419 as a third workload subgroup, networks 403 and 415 as a fourth workload subgroup, and network 407 as a fifth workload subgroup.

After identifying the workload subgroups, system 401 analyzes the networks of each subgroup to identify layer wise split boundaries (step 505). The layer wise split boundaries are representative of boundaries which identify the output data layers of a network. In an implementation, to identify the layer wise split boundaries, system 401 analyzes each network of each workload subgroup to select, label, or identify the layers within the networks that output data to memory. For example, when examining network 405, system 401 may select, label, or identify output data layers 445, 447, 449, and 451, and in turn identify layer boundaries 446, 448, 450, and 452.

After identifying the layer wise split boundaries of each workload subgroup, system 401 splits the workload subgroups into a number of workload fragments based on the layer wise split boundaries (step 507). For example, system 401 may split network 405 into a total of four workload fragments based on layer boundaries 446, 448, 450, and 452. In an implementation, system 401 splits each network into a number of workload fragments, such that the total number of workload fragments is equal to the workload of the respective network.

Finally, system 401 determines an execution time for executing each workload fragment (step 509). In an implementation, to determine the execution time for executing each workload fragment, system 401 simulates a PSUT environment. For example, system 401 may direct a singular processing core of system 401 to execute each workload fragment and in response, observe the time it takes the processing core to execute each workload fragment. As a result, system 401 may generate an execution schedule for executing the workload fragments, discussed in detail with reference to FIG. 5B.

FIG. 5B illustrates scheduling process 510 in an implementation. Scheduling process 510 is representative of a process for scheduling the execution of workload fragments across multiple processing cores. For example, scheduling process 510 may be representative of scheduling method 200 of FIG. 2. Scheduling process 510 may be implemented in the context of program instructions that, when executed by a suitable computing system, direct the processing circuitry of the computing system to operate as follows, referring parenthetically to the steps in FIG. 5B. For the purposes of explanation, scheduling process 510 will be explained as a process for scheduling the workload fragments identified via partitioning process 500 (with respect to the elements of FIG. 4A). This specification is not meant to limit the applications of scheduling process 510, but rather to provide an example.

To begin, system 401 analyzes the workload fragments to identify a number of workload fragment sets (step 511). A workload fragment set is representative of a set of one or more workload fragments which are configured to process related sections of data. For example, a workload fragment set may comprise two workload fragments, such that the output data of a first workload fragment is representative of the input data to a second workload fragment. Alternatively, a workload fragment set may comprise a singular workload fragment which outputs data to memory.

Next, system 401 labels the workload fragments of the workload fragment sets as producer workload fragments or consumer workload fragments (step 513). A producer workload fragment is representative of a fragment that produces input data for another workload fragment. Alternatively, a consumer workload fragment is representative of a fragment that consumes the output data of a producer workload fragment. In an implementation, system 401 may also label the workload fragments as null fragments. A null fragment is representative of a fragment that is neither a producer workload fragment nor a consumer workload fragment.

After labeling the workload fragments as consumer, producer, or null workload fragments, system 401 places the consumer workload fragments on a timeline based on the associated sensor latency (step 515). The timeline is representative of a schedule for executing the workload fragments across the multiple processing cores. In an implementation, system 401 places the consumer workload fragments on the timeline based on the sensor latency associated with the network. For example, if the consumer fragment is associated with network 405, then system 401 may place the consumer fragment on the timeline based on a sensor latency of T1. Alternatively, if the consumer fragment is associated with network 407, then system 401 may place the consumer fragment on the timeline based on a sensor latency of T4. In an implementation, system 401 also places the null fragments on the timeline based on the associated sensor latency.

Next, system 401 places the producer workload fragments on the timeline based on the placement of an associated consumer workload fragment (step 517). In an implementation, if a workload fragment set comprises multiple producer and consumer workload fragments, then system 401 may place the producer workload fragment on the timeline based on a placement of a previous producer workload fragment. For example, if a workload fragment set comprises three workload fragments including a producer fragment, a producer/consumer fragment, and a consumer fragment, then system 401 will first place the consumer fragment on the timeline based on an associated sensor latency, then place the producer/consumer fragment on the timeline based on the placement of the consumer fragment, and finally place the producer fragment on the timeline based on the placement of the producer/consumer fragment.

After placing each workload fragment set on the timeline, system 401 analyzes the timeline to determine if the start time is less than zero (step 519). The start time of the timeline is representative of the time that system 401 is allowed to begin executing workload fragments. For example, if system 401 will finish executing a workload fragment at +20 milliseconds (i.e., the latency), and the execution time of the fragment is thirty milliseconds, then system 401 can determine that the start time for the fragment is −10 milliseconds (i.e., less than zero). In an implementation, if the start time is greater than zero, then system 401 may determine the execution times of the workload fragment sets satisfy the associated sensor latencies. Alternatively, if the start time is less than zero, then system 401 may determine the execution time of at least one of the workload fragment sets exceeds the associated sensor latency.

In an implementation, if system 401 determines the start time is less than zero, then system 401 will identify or select the workload fragment sets with an execution time that exceeds the associated sensor latency (step 521). System 401 may be configured to identify workload fragment sets by comparing each execution time with the associated sensor latency. Once identified, system 401 determines a split type for splitting the identified workload fragment sets. The split type is representative of a method for partitioning the workload fragment sets into smaller units. For example, system 401 may employ a channel wise split, spatial wise split, or another split type of the like to split the identified workload fragments into a number of workload fragment subsets (step 523).

After splitting the identified workload fragment sets into a number of workload fragment subsets, system 401 places the workload fragment subsets on the timeline in parallel (step 525). Once placed, system 401 may determine if the start time is still less than zero (step 519). If the start time is still less than zero, then system 401 may repeat steps 521, 523, and 525. Alternatively, if the start time is greater than zero, then system 401 may schedule the execution of the timeline on the multiple processing cores of system 401 (step 526).

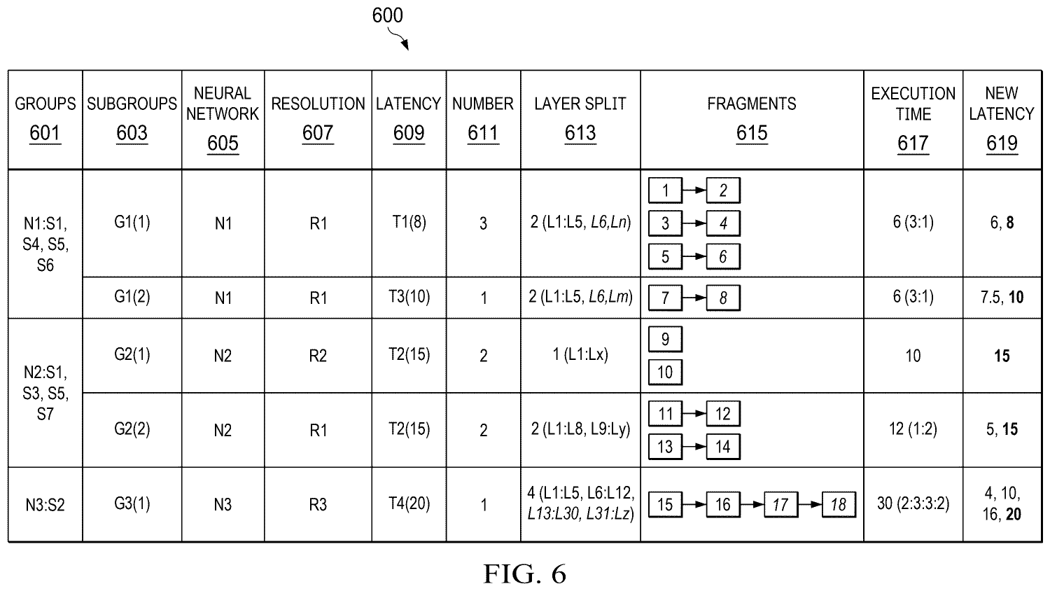

FIG. 6 illustrates table 600 in an implementation. Table 600 is representative of a table which stores information related to the partitioning and scheduling of operating environment 400. Table 600 includes groups column 601, subgroups column 603, network column 605, resolution column 607, latency column 609, number column 611, layer split column 613, fragments column 615, execution time column 617, and new latency column 619.

Groups column 601 is representative of a column which stores information related to the various workload groups of system 401. In an implementation, a workload group includes workloads of the same network (as displayed by network column 605). For example, system 401 includes three workload groups such that the first workload group includes networks 405, 411, 413, and 417 (i.e., N1), the second workload group includes networks 403, 409, 415, and 419 (i.e., N2), and the third workload group includes network 407 (i.e., N3).

Subgroups column 603 is representative of a column which stores information related to the workload subgroups of system 401. In an implementation, a workload subgroup includes workloads of the same network, same sensor resolution (as displayed by resolution column 607), and same latency (as displayed by latency column 609). For example, system 401 includes five workload subgroups such that the first workload subgroup includes networks 405, 411, and 417 (i.e., N1, R1, T1), the second workload subgroup includes network 413 (i.e., N1, R1, T3), the third workload subgroup includes networks 409 and 419 (i.e., N2, R2, T2), the fourth workload subgroup includes networks 403 and 415 (i.e., N2, R1, T2), and the fifth workload subgroup includes network 407 (i.e., N3, R3, T4).

Numbers column 611 is representative of a column which stores a number of instances of each workload subgroup. In an implementation, the number of instances of each workload subgroup is dependent on the number of networks within each workload subgroup. For example, the first workload subgroup includes three networks while the second workload subgroup includes a single network. Meaning, there are three instances of the first workload subgroup and one instance of the second workload subgroup.

Layer split column 613 is representative of a column which stores information related to the fragmentation of the workload subgroups. In an implementation, layer split column 613 is representative of a column which stores a number of workload fragments for each workload subgroup. For example, the second workload subgroup may be split into two workload fragments, such that the first fragment represents the first five layers of network 413 and the second fragment represents the remaining layers of network 413. In an implementation, system 401 partitions the workload subgroups into a total of 18 workload fragments.

Fragments column 615 is representative of a column which stores the fragments for each workload subgroup. For example, the first workload subgroup includes six workload fragments, the second workload subgroup includes two workload fragments, the third workload subgroup includes two workload fragments, the fourth workload subgroup includes four workload fragments, and the fifth workload subgroup includes four workload fragments. It should be noted that the first, third, and fourth workload subgroups include multiple instances of the same fragments. For example, the third workload subgroup includes two instances of the same fragment such that the first instance is representative of the ninth workload fragment, and the second instance is representative of the tenth workload fragment.

Execution times column 617 is representative of a column which stores the execution times for executing the fragments of fragments column 615. For example, the execution times for executing the first and second fragments, the third and fourth fragments, and the fifth and six fragments is equal to 6 milliseconds, such that it takes 4.5 milliseconds to execute the first, third, and fifth fragments and 1.5 milliseconds to execute the second, fourth, and sixth fragments.

New latency column 619 is representative of a column which stores the desired latencies for executing the workload fragments. For example, the first and second fragments, third and fourth fragments, and fifth and sixth fragments must each be executed within 8 milliseconds, such that the first, third, and fifth fragments are executed within the first 6 milliseconds of the 8 milliseconds, and the second, fourth, and sixth fragments are executed within the remaining 2 milliseconds of the 8 milliseconds.

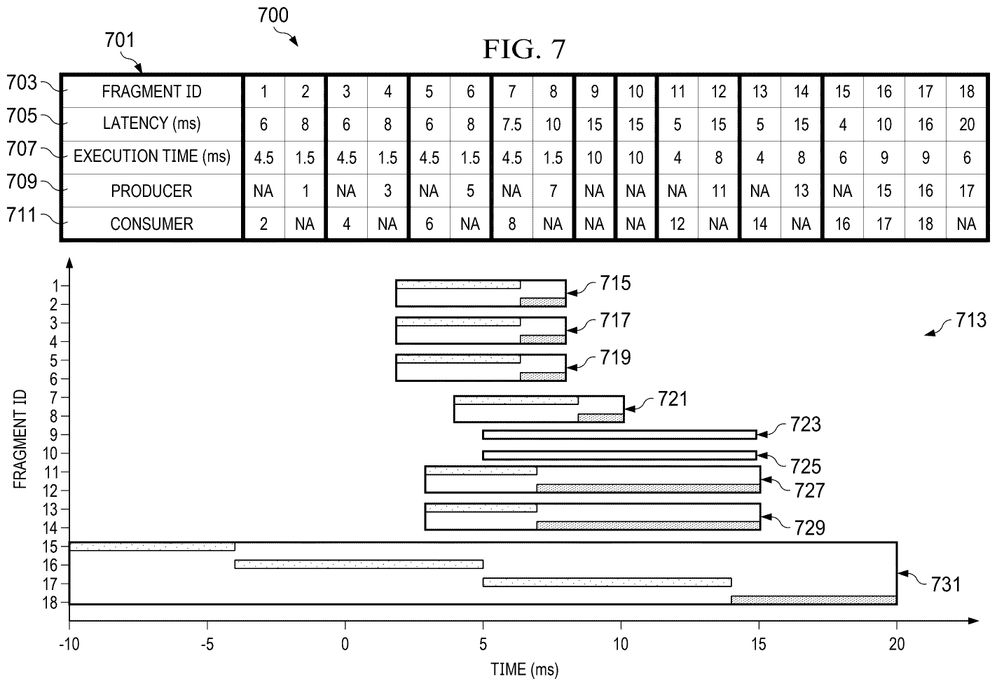

FIG. 7 illustrates operational scenario 700 in an implementation. Operational scenario 700 is representative of a scenario for generating an execution schedule for executing the networks of system 401 across multiple processing cores. Operational scenario 700 includes table 701 and timeline 713.

Table 701 is representative of a table which stores information related to the workload fragments of system 401. In an implementation, table 701 stores data related to the fragments identified by table 600. Table 701 includes fragment ID row 703, latency row 705, execution time row 707, producer fragment row 709, and consumer fragment row 711.

Fragment ID row 703 is representative of a row which stores identifications for the workload fragments of system 401. In an implementation, system 401 includes 18 workload fragments. As such, fragment ID row 703 stores identifications for the 18 workload fragments.

Latency row 705 is representative of a row which stores a desired latency for executing the workload fragments. For example, the desired latency for executing the first and second fragment is equal to 8 milliseconds such that it is desired to execute the first workload fragment within the first 6 milliseconds of the 8 milliseconds and execute the second workload fragment within the remaining 2 milliseconds of the 8 milliseconds. In another example, the desired latency for executing the seventh and eighth fragments is equal to 10 milliseconds such that it is desired to execute the seventh workload fragment within the first 7.5 milliseconds of the 10 milliseconds and execute the eighth workload fragment within the remaining 2.5 milliseconds of the 10 milliseconds.

Execution time row 707 is representative of a row which stores the execution times for executing the workload fragments of system 401. For example it takes 4.5 milliseconds to execute the first, third, fifth, and seventh workload fragments, 1.5 milliseconds to execute the second, fourth, sixth, and eighth workload fragments, 10 milliseconds to execute the ninth and tenth workload fragments, 4 milliseconds to execute the eleventh and thirteenth workload fragments, 8 milliseconds to execute the twelfth and fourteenth workload fragments, 6 milliseconds to execute the fifteenth and eighteenth workload fragments, and 9 milliseconds to execute the sixteenth and seventeenth workload fragments.

Producer row 709 is representative of a row which identifies the producer workload fragments of system 401. A producer workload fragment is representative of a fragment which produces input data for another workload fragment. For example, the fifteenth workload fragment is a producer for the sixteenth workload fragment, the sixteenth workload fragment is a producer for the seventeenth workload fragment, and the seventeenth workload fragment is a producer for the eighteenth workload fragment. In an implementation, producer row 709 provides an indication to whether a workload fragment has a corresponding producer workload fragment. For example, the first workload fragment does not have a corresponding producer workload fragment, but the second workload fragment does have a corresponding producer workload fragment (i.e., the first workload fragment).

Consumer row 711 is representative of a row which identifies the consumer workload fragments of system 401. A consumer workload fragment is representative of a fragment which receives input data from a producer workload fragment. For example, the eighteenth workload fragment is a consumer for the seventeenth workload fragment, the seventeenth workload fragment is a consumer for the sixteenth workload fragment, and the sixteenth workload fragment is a consumer for the fifteenth workload fragment. In an implementation, consumer row 711 provides indication to whether a workload fragment has a corresponding consumer workload fragment. For example, the first workload fragment does have a corresponding consumer fragment (i.e., the second workload fragment), but the second workload fragment does not.

Timeline 713 is representative of a timeline for scheduling the execution of the workload fragments of system 401 across multiple processing cores. For example, timeline 713 may be representative of an execution schedule for executing the workload fragments. Timeline 713 includes workload fragment sets 715, 717, 719, 721, 723, 725, 727, 729, and 731.

Workload fragment sets 715, 717, 719, 721, 723, 725, 727, 729, and 731 represent sets of producer and consumer workload fragments, as well as sets of null workload fragments. For example, workload fragment set 715 includes the first and second workload fragments, workload fragment set 717 includes the third and fourth workload fragments, workload fragment set 719 includes the fifth and sixth workload fragments, workload fragment set 721 includes the seventh and eighth workload fragments, workload fragment set 723 includes the ninth workload fragment, workload fragment set 725 includes the tenth workload fragment, workload fragment set 727 includes the eleventh and twelfth workload fragments, workload fragment set 729 includes the thirteenth and fourteenth workload fragments, and workload fragment set 731 includes the fifteenth, sixteenth, seventeenth, and eighteenth workload fragments.

In an implementation, system 401 places the workload fragment sets on timeline 713 in accordance with scheduling process 510. In a brief operational example, system 401 first places the consumer workload fragments and the null workload fragments on timeline 713 based on the associated sensor latency. For example, system 401 may place the second workload fragment on timeline 713, such that the placement of the second workload fragment aligns with the desired latency. Meaning, the placement of the second workload fragment illustrates that the execution of the second workload fragment completes at the 8-millisecond mark.

Next system 401 places the producer workload fragments on timeline 713 based on a placement of the associated consumer workload fragment. For example, system 401 may place the first workload fragment on timeline 713, such that the placement of the first workload fragment aligns with the placement of the associated consumer workload fragment. Meaning, the placement of the first workload fragment illustrates that the execution of the first workload fragment completes immediately before the execution of the second workload fragment.

In an implementation, after placing workload fragment sets 715, 717, 719, 721, 723, 725, 727, 729, and 731 on timeline 713, system 401 analyzes timeline 713 to determine if the start time for executing any of the workload fragments is less than zero. For example, system 401 may determine the start time for executing the fifteenth and sixteenth workload fragments is less than zero. As a result, system 401 identifies a split type for splitting up the fragments of workload fragment set 731 into smaller units.

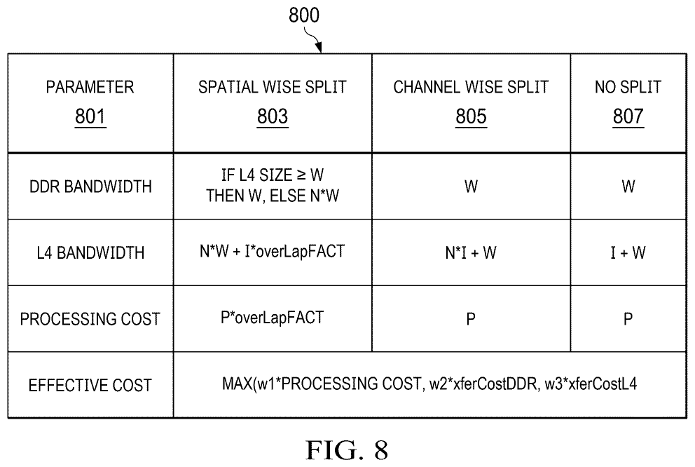

FIG. 8 illustrates split type table 800 in an implementation. Split type table 800 is representative of a table for determining a split type for splitting the workload of one or more workload fragment sets into smaller units. For example, split type table 800 may be representative of a table for determining a split type for workload fragment set 731 of FIG. 7. For the purposes of explanation, split type table 800 will be explained with respect to the elements of FIGS. 4A and 7. This is not meant to limit the applications of split type table 800, but rather to provide an example. Split type table 800 includes parameter column 801, spatial wise split column 803, channel wise split column 805, and no split column 807.

Parameter column 801 is representative of a column which stores parameters for determining the optimal split type. In an implementation, system 401 determines the optimal split type based on a comparison between the DDR bandwidth, L4 bandwidth, and the processing costs of the various split types. The DDR bandwidth is representative of the rate at which data may be read from or stored to a DDR memory. Similarly, the L4 bandwidth is representative of the rate at which data may be read from or stored to an L4 memory. Alternatively, the processing costs of the various split types are representative of the processing costs system 401 must endure to perform the desired split type. In an implementation, to determine the split type for splitting workload fragment set 731, system 401 selects the split type with the highest DDR bandwidth, highest L4 bandwidth, and lowest processing cost.

Spatial wise split column 803 is representative of a column which stores data related to performing a spatial wise split of a workload fragment set. A spatial wise split is representative of a split type where the layers of the network are split on a spatial basis. In an implementation, the DDR bandwidth of a spatial wise split is based on the parameter size (i.e., W) of the workload fragment set. For example, if the parameter size of workload fragment set 731 is equal to W, then the DDR bandwidth of the spatial wise split is equal to W if the size of an associated L4 memory is greater than or equal to the size of W. Alternatively, if the size of the associated L4 memory is less than the size of W, then the DDR bandwidth is equal to the number of processing cores which will be used to execute workload fragment set 731 (i.e., N) multiplied by the size of W.

In an implementation, the L4 bandwidth of a spatial wise split is based on spatial filter height. For example, the L4 bandwidth when performing a spatial wise split on workload fragment set 731 may be calculated with the following equation:

$$L 4 Bandwidth = ( N * W ) + ( I * overlapFACT ) \qquad ( 1 )$$

Such that N is representative of the number of processing cores used to execute workload fragment set 731, W is representative of the parameter size of workload fragment set 731, I is representative of an input tensor size of workload fragment set 731, and overLapFact is representative of the additional data needed to satisfy the spatial filter height.

In an implementation, the processing cost for performing a spatial wise split is based on the number of processing cycles (i.e., P) required by the workload fragment set. For example, the processing cost for spatially splitting workload fragment set 731 is equal to the number of processing cycles required to execute workload fragment set 731 multiplied by the overLapFACT.

Channel wise split column 805 is representative of a column which stores data related to performing a channel wise split of a workload fragment set. A channel wise split is representative of a split type where the layers of the network are split on a channel basis. For example, if the network comprises red, green, and blue channels, then the processing requirements of the network may be split across the red, green, and blue channels. In an implementation, the DDR bandwidth for performing a channel wise split on a workload fragment set is based on the parameter size (i.e., W) of the workload fragment set. For example, the DDR bandwidth for performing a channel wise split on workload fragment set 731 is equal to the parameter size of workload fragment set 731.

In an implementation, the L4 bandwidth of a channel wise split is based on data of the workload fragment set. For example, the L4 bandwidth when performing a channel wise split on workload fragment set 731 may be calculated with the following equation:

$$L 4 Bandwidth = ( N * I ) + W \qquad ( 2 )$$

Such that N is representative of the number of processing cores used to execute workload fragment set 731, I is representative of an input tensor size of workload fragment set 731, and W is representative of the parameter size of workload fragment set 731.

In an implementation, the processing cost for performing a channel wise split is based on the number of processing cycles (i.e., P) required by the workload fragment set. For example, the processing cost for splitting workload fragment set 731 by channels is equal to the number of processing cycles required to execute workload fragment set 731.

No split column 807 is representative of a column which stores data related to a workload fragment set. Meaning, no split column 807 stores data for when no split occurs. In an implementation, the DDR bandwidth to not split a workload fragment set is based on the parameter size (i.e., W) of the workload fragment set. For example, the DDR bandwidth for workload fragment set 731 is equal to the parameter size of workload fragment set 731.

In an implementation, the L4 bandwidth to not split a workload fragment set is based on data of the workload fragment set. For example, the L4 bandwidth for workload fragment set 731 may be calculated with the following equation:

$$L 4 Bandwidth = I + W \qquad ( 3 )$$

Such that I is representative of the input tensor size of workload fragment set 731 and W is representative of the parameter size of workload fragment set 731.

In an implementation, the processing cost to not split a workload fragment set is based on the number of processing cycles (i.e., P) required by the workload fragment set. For example, the processing cost to not split workload fragment set 731 is equal to the number of processing cycles required to execute workload fragment set 731.

In an implementation, to determine the optimal split type for a workload fragment set, system 401 compares the effective costs for executing the various split types. For example, to determine the effective costs for splitting workload fragment set 731 via the various split types, system 401 may employ the following equation:

$$Effective Cost = MAX ( {w}_{1} * ProcessingCost , {w}_{2} * xferCostDDR , {w}_{3} * xferCostL 4 \qquad ( 4 )$$

Such that w1, w2, and w3 are representative of weight factors, ProcessingCost is representative of the determined processing cost for each split type, xferCostDDR is representative of a number of cycles required to access data from DDR memory, and xferCostL4 is representative of a number of cycles required to access data from L4 memory. In an implementation, system 401 determines the split type based on which split type has the lowest effective cost.

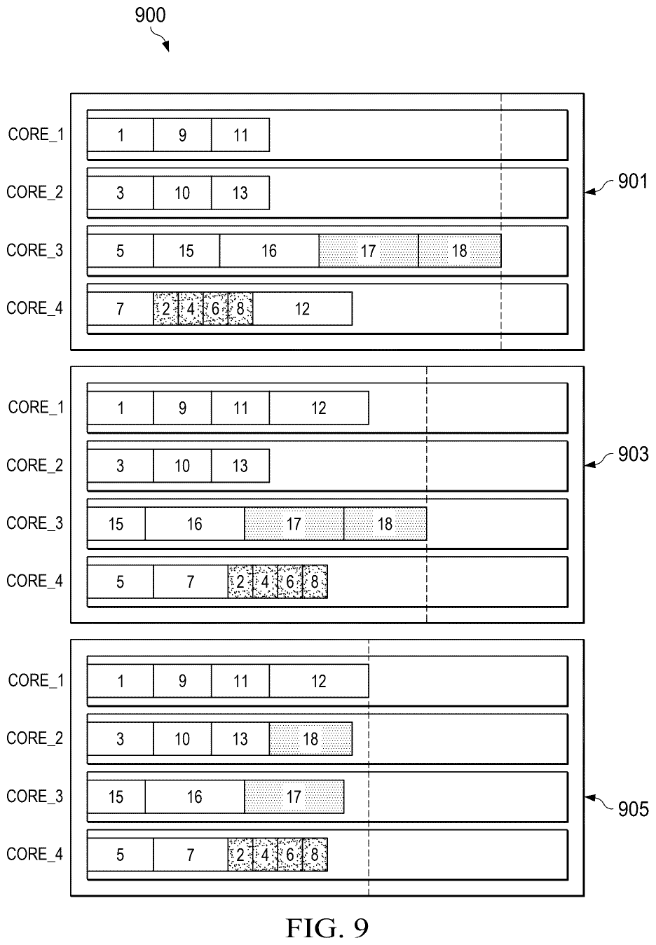

Now turning to the next figure, FIG. 9 illustrates operational scenario 900 in an implementation. Operational scenario 900 is representative of a scenario for executing multiple neural networks across multiple processing cores. For the purposes of explanation, operational scenario 900 will be explained with respect to the elements of FIG. 4A. This is not meant to limit the applications of operational scenario 900, but rather to provide an example. Operational scenario 900 includes execution schedule 901, execution schedule 903, and execution schedule 905.

Execution schedule 901 is representative of an exemplary schedule for executing the networks of system 401 across multiple processing cores. For example, system 401 may comprise four processing cores configured to execute workload fragments. In an implementation, the processing cores of system 401 are representative of DSPs, such that the first DSP is configured to execute the first, ninth, and eleventh workload fragments, the second DSP is configured to execute the third, tenth, and thirteenth workload fragments, the third DSP is configured to execute the fifth, fifteenth, sixteenth, seventeenth, and eighteenth workload fragments, and the fourth DSP is configured to execute the seventh, second, fourth, sixth, eighth, and twelfth workload fragments. Advantageously, execution schedule 901 attempts to schedule the execution of the workload fragments of the same network in parallel, and in turn, reduces the number of times system 401 is required to fetch weight data from memory.

Execution schedule 903 is representative of another exemplary schedule for executing the networks of system 401 across the multiple processing cores. For example, if the processing cores of system 401 are representative of DSPs, then the first DSP is configured to execute the first, ninth, eleventh, and twelfth workload fragments, the second DSP is configured to execute the third, tenth, and thirteenth workload fragments, the third DSP is configured to execute the fifteenth, sixteenth, seventeenth, and eighteenth workload fragments, and the fourth DSP is configured to execute the fifth, seventh, second, fourth, sixth, and eighth workload fragments. Advantageously, execution schedule 903 attempts to schedule the execution of the workload fragments of the same network on the same processing core, and in turn, reduces the number of times system 401 is required to fetch weight data from memory.

Execution schedule 905 is also representative of an exemplary schedule for executing the networks of system 401 across the multiple processing cores. For example, if the processing cores of system 401 are representative of DSPs, then the first DSP is configured to execute the first, ninth, eleventh, and twelfth workload fragments, the second DSP is configured to execute the third, tenth, thirteenth, and eighteenth workload fragments, the third DSP is configured to execute the fifteenth, sixteenth, and seventeenth workload fragments, and the fourth DSP is configured to execute the fifth, seventh, second, fourth, sixth, and eighth workload fragments. Advantageously, execution schedule 905 attempts to generate a schedule that load balances the workload fragments across the multiple processing cores of system 401, and in turn, increases the load balance effectiveness for executing the networks of system 401.

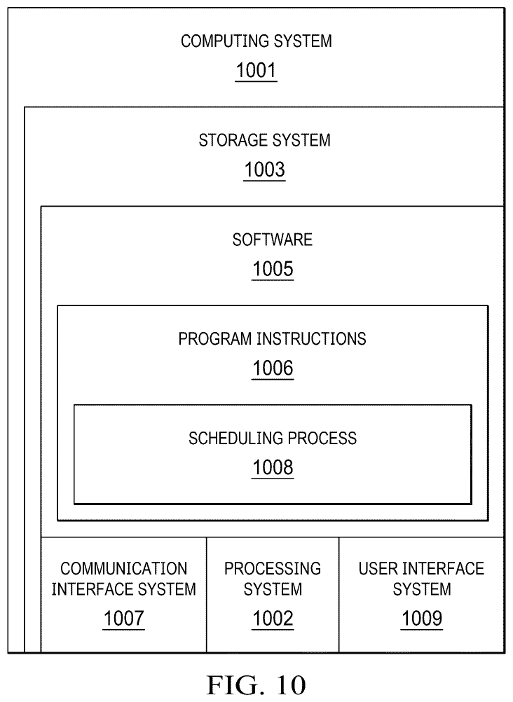

FIG. 10 illustrates an example computer system that may be used in various implementations. For example, computing system 1001 is representative of a computing device capable of scheduling the execution of one or more neural networks across one or more processing cores as described herein. Computing system 1001 is representative of any system or collection of systems with which the various operational architectures, processes, scenarios, and sequences disclosed herein for scheduling and executing neural networks across multiple processing cores may be employed. Examples of computing system 1001 include—but are not limited to—micro controller units (MCUs), embedded computing devices, server computers, cloud computers, personal computers, mobile phones, and the like.

Computing system 1001 may be implemented as a single apparatus, system, or device or may be implemented in a distributed manner as multiple apparatuses, systems, or devices. Computing system 1001 includes, but is not limited to, processing system 1002, storage system 1003, software 1005, communication interface system 1007, and user interface system 1009 (optional). Processing system 1002 is operatively coupled with storage system 1003, communication interface system 1007, and user interface system 1009. Computing system 1001 may be representative of a cloud computing device, distributed computing device, or the like.

Processing system 1002 loads and executes software 1005 from storage system 1003, or alternatively, runs software 1005 directly from storage system 1003. Software 1005 includes program instructions 1006, which includes scheduling process 1008 (e.g., scheduling method 200, partitioning process 500, or scheduling process 510). When executed by processing system 1002, software 1005 directs processing system 1002 to operate as described herein for at least the various processes, operational scenarios, and sequences discussed in the foregoing implementations. Computing device 1001 may optionally include additional devices, features, or functions not discussed for purposes of brevity.

Referring still to FIG. 10, processing system 1002 may comprise a micro-processor and other circuitry that retrieves and executes software 1005 from storage system 1003. Processing system 1002 may be implemented within a single processing device but may also be distributed across multiple processing devices or sub-systems that cooperate in executing program instructions. Examples of processing system 1002 include general purpose central processing units, graphical processing units, digital signal processing units, data processing units, application specific processors, and logic devices, as well as any other type of processing device, combinations, or variations thereof.

Storage system 1003 may comprise any computer readable storage media readable and writeable by processing system 1002 and capable of storing software 1005. Storage system 1003 may include volatile and nonvolatile, removable and non-removable, mutable and non-mutable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 1003 may also include computer readable communication media over which at least some of software 1005 may be communicated internally or externally. Storage system 1003 may be implemented as a single storage device but may also be implemented across multiple storage devices or sub-systems co-located or distributed relative to each other. Storage system 1003 may comprise additional elements, such as a controller, capable of communicating with processing system 1002 or possibly other systems.

Software 1005 may be implemented in program instructions 1006 and among other functions may, when executed by processing system 1002, direct processing system 1002 to operate as described with respect to the various operational scenarios, sequences, and processes illustrated herein. In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 1005 may include additional processes, programs, or components, such as operating system software, virtualization software, or other application software. Software 1005 may also comprise firmware or some other form of machine-readable processing instructions executable by processing system 1002.

In general, software 1005 may, when loaded into processing system 1002 and executed, transform a suitable apparatus, system, or device (of which computing device 1001 is representative) overall from a general-purpose computing system into a special-purpose computing system customized to support binary convolution operations. Indeed, encoding software 1005 (and scheduling process 1008) on storage system 1003 may transform the physical structure of storage system 1003. The specific transformation of the physical structure may depend on various factors in different implementations of this description. Examples of such factors may include, but are not limited to, the technology used to implement the storage media of storage system 1003 and whether the computer-storage media are characterized as primary or secondary, etc.

For example, if the computer readable storage media are implemented as semiconductor-based memory, software 1005 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 1007 may include communication connections and devices that allow for communication with other computing systems (not shown) over communication networks (not shown). Examples of connections and devices that together allow for inter-system communication may include network interface cards, antennas, power amplifiers, radiofrequency circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing system 1001 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of networks, or variation thereof. The aforementioned communication networks and protocols are well known and need not be discussed at length here.

As will be appreciated by one skilled in the art, aspects of the present invention may be embodied as a system, method, or computer program product. Accordingly, aspects of the present invention may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Indeed, the included descriptions and figures depict specific implementations to teach those skilled in the art how to make and use the best mode. For the purpose of teaching inventive principles, some conventional aspects have been simplified or omitted. Those skilled in the art will appreciate variations from these implementations that fall within the scope of the disclosure. Those skilled in the art will also appreciate that the features described above may be combined in various ways to form multiple implementations. As a result, the invention is not limited to the specific implementations described above, but only by the claims and their equivalents.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. Thus, the invention is not limited to the specific embodiments described above, but only by the following claims and their equivalents.

What is claimed is:

1. A non-transitory computer-readable medium having executable instructions stored thereon, configured to be executable by processing circuitry for causing the processing circuitry to:
identify a plurality of workload fragments of a neural network based on a sensor type and a desired latency associated with each workload fragment of the plurality of workload fragments;
determine an execution time for executing each workload fragment of the plurality of workload fragments; and
generate a schedule for executing the neural network on multiple processing cores based on the desired latency associated with each workload fragment and the execution time for executing each workload fragment.

2. The non-transitory computer-readable medium of claim 1, wherein the instructions are executable by the processing circuitry for further causing the processing circuitry to:
identify one or more layer boundaries of one or more workload subgroups; and
split the one or more workload subgroups into the plurality of workload fragments based on the one or more layer boundaries of the one or more workload subgroups.

3. The non-transitory computer-readable medium of claim 2, wherein the instructions are executable by the processing circuitry for further causing the processing circuitry to:
identify one or more sensors associated with the neural network;
identify a sensor type and a desired latency of each of the one or more sensors; and
split the neural network into the one or more workload subgroups based on the sensor type and the desired latency of each of the one or more sensors.

4. The non-transitory computer-readable medium of claim 1, wherein to generate the schedule for executing the neural network, the instructions further cause the processing circuitry to:
generate a timeline for scheduling the execution of the plurality of workload fragments on the multiple processing cores;
identify one or more workload fragment sets, wherein the one or more workload fragment sets comprises a producer workload fragment and a consumer workload fragment;
for each workload fragment set of the one or more workload fragment sets:
place the consumer workload fragment on the timeline based on a desired latency associated with the consumer workload fragment; and
place the producer workload fragment on the timeline based on a placement of the consumer workload fragment.

5. The non-transitory computer-readable medium of claim 4, wherein the instructions are executable by the processing circuitry for further causing the processing circuitry to, for each workload fragment set of the one or more workload fragment sets:
determine an execution time for executing the workload fragment set;
determine the execution time for executing the workload fragment set is greater than a desired latency associated with the workload fragment set;
determine a split type for the workload fragment set;
split the workload fragment set into multiple workload fragment subsets based on the determined split type; and
place the multiple workload fragment subsets on the timeline in parallel.

6. The non-transitory computer-readable medium of claim 5, wherein the split type includes a spatial division split type and an output channel division split type.

7. The non-transitory computer-readable medium of claim 4, wherein the instructions are executable by the processing circuitry for further causing the processing circuitry to, for each workload fragment set of the one or more workload fragment sets:
determine an execution time for executing the workload fragment set; and
determine the execution time for executing the workload fragment set is less than a desired latency associated with the workload fragment set.

8. A system comprising:
a sensor interface configurable to receive input data from a plurality of sensors; and
multiple processing cores configurable to execute a neural network based on a schedule generated by at least:
identifying a plurality of workload fragments in the neural network based on a sensor type and a desired latency of each sensor of the plurality of sensors; and
determining an execution time for executing each workload fragment of the plurality of workload fragments.

9. The system of claim 8, wherein the schedule is further generated by:
identifying one or more layer boundaries of one or more workload subgroups; and
splitting the one or more workload subgroups into the plurality of workload fragments based on the one or more layer boundaries of the one or more workload subgroups.

10. The system of claim 9, wherein the schedule is further generated by:
identifying the sensor type and the desired latency of each sensor of the plurality of sensors; and
splitting the neural network into the one or more workload subgroups based on the sensor type and the desired latency of each sensor of the plurality of sensors.

11. The system of claim 8, wherein the schedule is further generated by:
generating a timeline for scheduling the execution of the plurality of workload fragments on the multiple processing cores;
identifying one or more workload fragment sets, wherein the one or more workload fragment sets comprises a producer workload fragment and a consumer workload fragment;
for each workload fragment set of the one or more workload fragment sets:
placing the consumer workload fragment on the timeline based on a desired latency of an associated sensor; and
placing the producer workload fragment on the timeline based on a placement of the consumer workload fragment.

12. The system of claim 11, wherein the schedule is further generated by, for each workload fragment set of the one or more workload fragment sets:
determining an execution time for executing the workload fragment set;
determining the execution time for executing the workload fragment set is greater than the desired latency of the associated sensor;
determining a split type for the workload fragment set;
splitting the workload fragment set into multiple workload fragment subsets based on the determined split type; and
placing the multiple workload fragment subsets on the timeline in parallel.

13. The system of claim 12, wherein the split type includes a spatial division split type and an output channel division split type.

14. The system of claim 11, wherein the schedule is further generated by, for each workload fragment set of the one or more workload fragment sets:
determining an execution time for executing the workload fragment set; and
determining the execution time for executing the workload fragment set is less than the desired latency of the associated sensor.

15. A method comprising:
identifying a plurality of workload fragments of a neural network based on a sensor type of one or more sensors and a desired latency of the one or more sensors;
determining an execution time for executing each workload fragment of the plurality of workload fragments; and
generating a schedule for executing the neural network on multiple processing cores based on the desired latency of the one or more sensors and the execution time for executing each workload fragment.

16. The method of claim 15, further comprising:
identifying one or more layer boundaries of one or more workload subgroups; and
splitting the one or more workload subgroups into the plurality of workload fragments based on the one or more layer boundaries of the one or more workload subgroups.

17. The method of claim 16, further comprising:
identifying the sensor type and the desired latency of each of the one or more sensors; and
splitting the neural network into the one or more workload subgroups based on the sensor type and the desired latency of each of the one or more sensors.

18. The method of claim 15, wherein generating the schedule for executing the neural network further comprises:
generating a timeline for scheduling the execution of the plurality of workload fragments on the multiple processing cores;
identifying one or more workload fragment sets, wherein the one or more workload fragment sets comprises a producer workload fragment and a consumer workload fragment;
for each workload fragment set of the one or more workload fragment sets:
placing the consumer workload fragment on the timeline based on a desired latency of an associated sensor; and
placing the producer workload fragment on the timeline based on a placement of the consumer workload fragment.

19. The method of claim 18, further comprising, for each workload fragment set of the one or more workload fragment sets:
determining an execution time for executing the workload fragment set;
determining the execution time for executing the workload fragment set is greater than the desired latency of the associated sensor;
determining a split type for the workload fragment set;
splitting the workload fragment set into multiple workload fragment subsets based on the determined split type; and
placing the multiple workload fragment subsets on the timeline in parallel.

20. The method of claim 18, further comprising, for each workload fragment set of the one or more workload fragment sets:
determining an execution time for executing the workload fragment set; and
determining the execution time for executing the workload fragment set is less than the desired latency of the associated sensor.
